(19) United States
(12) Patent Application Publication
(10) Pub. No.: US 2026/0019203 A1
(43) Pub. Date: Jan. 15, 2026

(54) TERMINAL

(71) Applicant: NTT DOCOMO, INC., Tokyo (JP)

(72) Inventors: Takuma NAKAMURA, Tokyo (JP); Hiroki HARADA, Tokyo (JP)

(73) Assignee: NTT DOCOMO, INC., Tokyo (JP)

(21) Appl. No.: 18/995,213

(22) PCT Filed: Aug. 10, 2022
(86) PCT No.: PCT/JP2022/030679

§ 371 Date: Jan. 16, 2025

(51) Int. Cl. H04L 5/00

(52) U.S. Cl. CPC H04L 5/0044; H04L 5/0098

(57) ABSTRACT

A terminal includes: a control unit that selects a plurality of bands from among a first band for a first uplink, a second band for a second uplink which supplements the first uplink, a third band for a third uplink in which a frequency band is different from frequency bands in the first band and the second band, and a fourth band for a fourth uplink which supplements the third uplink; and a transmitting unit that performs an uplink transmission using a combination of component carriers allocated to the selected plurality of bands.

### TECHNICAL FIELD

The present disclosure relates to a terminal.

### BACKGROUND ART

The 3rd Generation Partnership Project (3GPP, registered trademark) specifies the 5th generation mobile communication system (also referred to as 5G, New Radio (NR), or Next Generation (NG)), and is also promoting next-generation specifications called Beyond 5G, 5G Evolution, or 6G.

In 3GPP Release 16, there have been discussions about switching between two component carriers included in an uplink band in carrier aggregation which uses multiple component carriers bundled together. In 3GPP Release 17, there have been discussions about switching between two or three component carriers included in two uplink bands in the carrier aggregation.

In 3GPP Release 18, there are discussions about switching among three or four uplink bands (see, for example, Non-Patent Literature 1). By bundling component carriers allocated to a band selected from among the three or four bands, a throughput in an uplink can be improved in comparison with the configuration up to Release 17.

### Citation List

### Non-Patent Literature

Non Patent Literature 1 “draft_MeetingReport_RAN_96 220609_eom”, 3GPP TSG RAN #96, Jun. 6, 2022

### SUMMARY OF INVENTION

However, in the conventional technology, there is no provision for selecting which of the three or four bands in order to improve the throughput in the uplink. As a result, there is a problem that only one uplink band not to be expected to achieve a high throughput can be selected.

Therefore, the following disclosure has been made in light of such a situation, and aims to provide a terminal capable of appropriately selecting multiple uplink bands.

An aspect of the disclosure is a terminal including a control unit that selects a plurality of bands from among a first band for a first uplink, a second band for a second uplink which supplements the first uplink, a third band for a third uplink in which a frequency band is different from frequency bands in the first band and the second band, and a fourth band for a fourth uplink which supplements the third uplink; and a transmitting unit that performs an uplink transmission using a combination of component carriers allocated to the selected plurality of bands.

An aspect of the disclosure is a terminal including a control unit that selects a plurality of bands from among a first band for a first uplink, a second band for a second uplink which supplements the first uplink, and a third band for a third uplink in which a frequency band is different from frequency bands in the first band and the second band; and a transmitting unit that performs an uplink transmission using a combination of component carriers included in the selected plurality of bands.

### BRIEF DESCRIPTION OF DRAWINGS

FIG. 1 is an overall schematic configuration diagram of a radio communication system 10 according to the embodiment.

FIG. 2 is a functional block configuration diagram of a UE 200.

FIG. 3 is a functional block configuration diagram of a gNB 100.

FIG. 4 is a diagram illustrating a band selection operation in Release 16.

FIG. 5 is a diagram illustrating a band selection operation in Release 17.

FIG. 6 is a diagram illustrating a band selection operation in Release 18.

FIG. 7 is a diagram illustrating a band selection operation in Release 16.

FIG. 8 is a diagram illustrating a band selection operation in Release 16.

FIG. 9 is a diagram illustrating operation example 2.

FIG. 10 is a diagram illustrating an example of a hardware configuration of the gNB 100 and the UE 200.

FIG. 11 is a diagram illustrating a configuration example of a vehicle 2001.

### MODES FOR CARRYING OUT THE INVENTION

Hereinafter, an embodiment will be described based on the drawings. Note that, the same functions and configurations are denoted by the same or similar reference signs, and their descriptions will be omitted as appropriate.

### EMBODIMENT

### (1) Overall Schematic Configuration of Radio Communication System 10

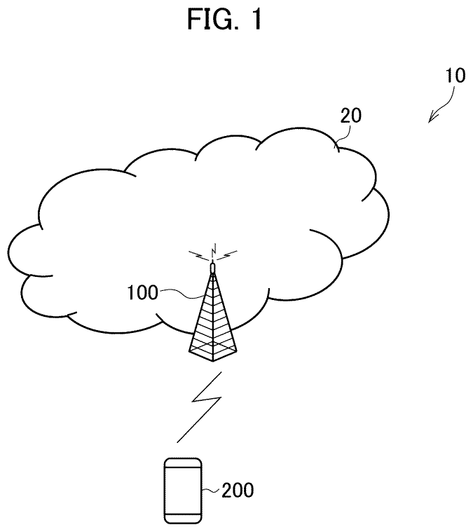

FIG. 1 is an overall schematic configuration diagram of a radio communication system 10 according to the embodiment. The radio communication system 10 is a radio communication system according to 5G New Radio (NR), and includes a Next Generation-Radio Access Network 20 (hereinafter, NG-RAN 20) and a terminal 200 (hereinafter, UE 200, User Equipment, UE). Note that the radio communication system 10 may be a radio communication system that conforms to a system called Beyond 5G, 5G Evolution, or 6G. The radio communication system 10 includes a gNB 100, the UE 200, the NG-RAN 20, and a core network.

The NG-RAN 20 includes the radio base station 100 (hereinafter, gNB 100). The NG-RAN 20 actually includes multiple NG-RAN Nodes, specifically, gNBs (or ng-eNBs), and is connected to the core network (e.g., 5GC) according to 5G. Note that, the NG-RAN 20 and the core network may be simply expressed as a “network”. The specific configuration of the radio communication system 10 including the gNB 100 and the UE 200 is not limited to that of the example illustrated in FIG. 1.

The gNB 100 is a radio base station according to 5G, and performs radio communication with the UE 200 according to 5G. The gNB 100 and the UE 200 can be compatible with Massive MIMO (Multiple-Input Multiple-Output) that generates a beam BM with higher directivity by controlling radio signals to be transmitted from multiple antenna elements, carrier aggregation (CA) that uses multiple component carriers (CCs) in a bundle, dual connectivity (DC) that communicates with two or more transport blocks at the same time between the UE and each of two NG-RAN Nodes, and the like.

The core network includes network devices. The network devices may include an LMF (Location Management Function), an AMF (Access and Mobility management Function), and the like. The network devices may include an E-SMLC (Evolved Serving Mobile Location Centre). The gNB 100 forms a radio communication node.

### (2) Functional Block Configuration of Radio Communication System 10

Next, a functional block configuration of the radio communication system 10 will be described.

First, a functional block configuration of the UE 200 will be described.

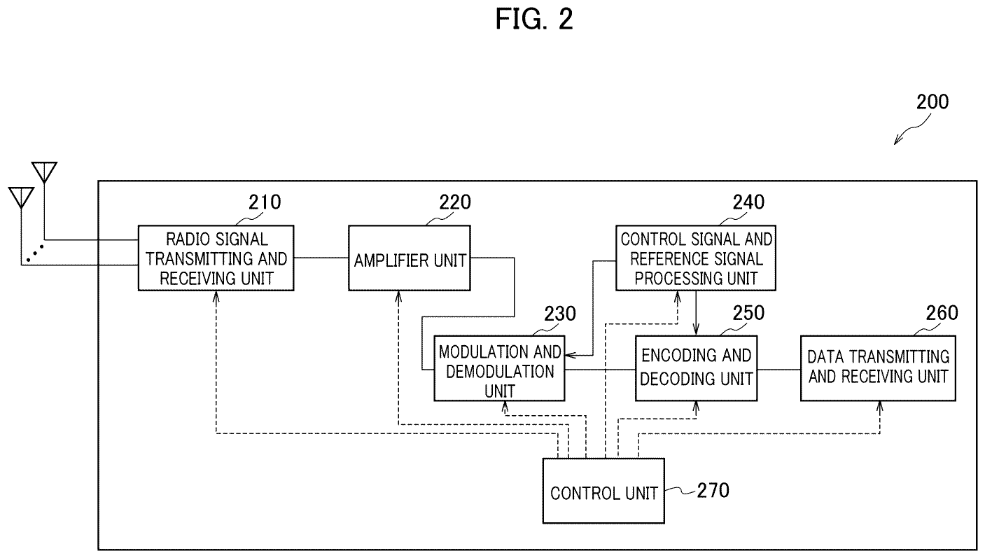

FIG. 2 is a functional block configuration diagram of the UE 200. As illustrated in FIG. 2, the UE 200 includes a radio signal transmitting and receiving unit 210, an amplifier unit 220, a modulation and demodulation unit 230, a control signal and reference signal processing unit 240, an encoding and decoding unit 250, a data transmitting and receiving unit 260, and a control unit 270.

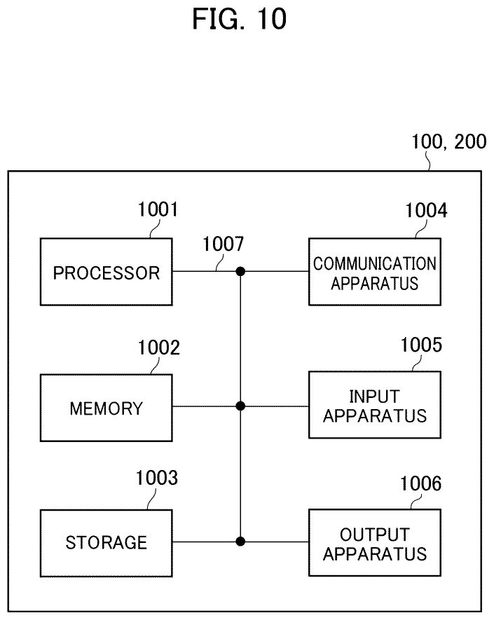

Note that FIG. 2 illustrates only main functional blocks related to the descriptions of the embodiment, and that the UE 200 has other functional blocks (e.g., a power supply unit and the like). Also, FIG. 2 illustrates the functional block configuration of the UE 200, and for the hardware configuration of the UE 200, refer to FIG. 10.

The radio signal transmitting and receiving unit 210 transmits and receives a radio signal according to NR. The radio signal transmitting and receiving unit 210 deals with Massive MIMO in which a more directional beam is generated by controlling radio (RF) signals to be transmitted from multiple antenna elements, a carrier aggregation (CA) in which multiple component carriers (CCs) are bundled and used, a dual connectivity (DC) in which communication is simultaneously performed between the UE 200 and each of two NG-RAN Nodes, and the like.

In the embodiment, the radio signal transmitting and receiving unit 210 may configure a transmitting unit to perform an uplink transmission using a combination of component carriers (CCs) allocated to a plurality of bands selected by the control signal and reference signal processing unit 240.

The amplifier unit 220 includes a PA (Power Amplifier)/LNA (Low Noise Amplifier) and the like. The amplifier unit 220 amplifies a signal output from the modulation and demodulation unit 230 to a predetermined power level. In addition, the amplifier unit 220 amplifies an RF signal output from the radio signal transmitting and receiving unit 210.

The modulation and demodulation unit 230 executes data modulation and demodulation, transmission power setting, resource block assignment, and the like for each predetermined communication destination (gNB 100 or another gNB). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for uplink (UL) but also for downlink (DL).

The control signal and reference signal processing unit 240 executes processing related to various control signals transmitted and received by the UE 200, and processing related to various reference signals transmitted and received by the UE 200.

Specifically, the control signal and reference signal processing unit 240 receives various control signals transmitted from the gNB 100 via a predetermined control channel, for example, a control signal of a radio resource control layer (RRC). Further, the control signal and reference signal processing unit 240 transmits various control signals to the gNB 100 via a predetermined control channel.

The control signal and reference signal processing unit 240 executes processing using a reference signal (RS) such as a Demodulation Reference Signal (DMRS) and a Phase Tracking Reference Signal (PTRS). The DMRS is a known specific reference signal (pilot signal) for the UE 200 between the base station and the UE 200 for estimating a phasing channel to be used for data demodulation. The PTRS is a specific reference signal for the UE 200 designed for the purpose of estimating a phase noise that is a problem in a high frequency band.

Note that, the reference signal may include a Channel State Information-Reference Signal (CSI-RS), a Sounding Reference Signal (SRS), and a Positioning Reference Signal (PRS) for position information, in addition to the DMRS and the PTRS.

In addition, the channel includes a control channel and a data channel. The control channel includes a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI), a Physical Broadcast Channel (PBCH), and the like.

In addition, the data channel includes a PDSCH (Physical Downlink Shared Channel), a PUSCH (Physical Uplink Shared Channel), and the like. Data means data transmitted via the data channel. The data channel may be interchanged with a shared channel.

The control signal and reference signal processing unit 240 may receive downlink control information (DCI). The DCI includes, as existing fields, fields for storing DCI Formats, Carrier indicator (CI), BWP indicator, FDRA (Frequency Domain Resource Assignment), TDRA (Time Domain Resource Assignment), MCS (Modulation and Coding Scheme), HPN (HARQ Process Number), NDI (New Data Indicator), RV (Redundancy Version), and the like.

A value stored in the DCI Format field is an information element specifying the format of the DCI. A value stored in the CI field is an information element specifying a CC for which the DCI is applied. A value stored in the BWP indicator field is an information element specifying a BWP for which the DCI is applied. The BWP that can be specified by the BWP indicator is configured by an information element (BandwidthPart-Config) included in an RRC message. A value stored in the FDRA field is an information element specifying a frequency domain resource for which the DCI is applied. The frequency domain resource is identified by a value stored in the FDRA field and an information element (RA Type) included in the RRC message. A value stored in the TDRA field is an information element specifying a time domain resource for which the DCI is applied. The time domain resource is identified by a value stored in the TDRA field and an information element (pdsch-TimeDomainAllocationList, pusch-TimeDomainAllocationList) included in the RRC message. The time domain resource may be identified by a value stored in the TDRA field and a default table. A value stored in the MCS field is an information element specifying an MCS for which the DCI is applied. The MCS is identified by a value stored in the MCS and an MCS table. The MCS table may be specified by the RRC message, or may be identified by RNTI scrambling. A value stored in the HPN field is an information element specifying a HARQ Process for which the DCI is applied. A value stored in the NDI is an information element for identifying whether data for which the DCI is applied is first transmission data. A value stored in the RV field is an information element specifying redundancy of data for which the DCI is applied.

In the embodiment, the control signal and reference signal processing unit 240 may configure a control unit that selects a plurality of bands from among a first band for a first uplink, a second band for a second uplink which supplements the first uplink, a third band for a third uplink in which a frequency band is different from frequency bands in the first band and the second band, a fourth band for a fourth uplink which supplements the third uplink. Details of the first uplink, the second uplink, the third uplink, and the fourth uplink will be described later. Details of the first band, the second band, the third band, and the fourth band will be described.

In the embodiment, the control signal and reference signal processing unit 240 may configure a control unit that selects a plurality of bands from among a first band for a first uplink, a second band for a second uplink which supplements the first uplink, and a third band for a third uplink in which a frequency band is different from frequency bands in the first band and the second band.

In the embodiment, the control signal and reference signal processing unit 240 may configure a control unit that selects the first band and the third band.

In the embodiment, the control signal and reference signal processing unit 240 may configure a control unit that sets the second band and the fourth band to be unselected. Setting the second band and the fourth band to be unselected may be interpreted as not selecting the second band and the fourth band.

In the embodiment, the control signal and reference signal processing unit 240 may configure a control unit that sets the second band and the third band to be unselected. Setting the second band and the third band to be unselected may be interpreted as not selecting the second band and the third band.

The encoding and decoding unit 250 performs data division and coupling, channel coding and decoding, and the like for each predetermined communication destination (gNB 100 or another gNB). Specifically, the encoding and decoding unit 250 divides data output from the data transmitting and receiving unit 260 into predetermined sizes, and performs channel coding on the divided data. Further, the encoding and decoding unit 250 decodes data output from the modulation and demodulation unit 230 and couples the decoded data.

The data transmitting and receiving unit 260 transmits and receives a Protocol Data Unit (PDU) and a Service Data Unit (SDU). Specifically, the data transmitting and receiving unit 260 performs assembly and disassembly of the PDU and SDU in multiple layers (a media access control layer (MAC), a radio link control layer (RLC), a packet data convergence protocol layer (PDCP), and the like). In addition, the data transmitting and receiving unit 260 executes error correction and retransmission control of data on the basis of HARQ (Hybrid Automatic Repeat Request).

The control unit 270 controls each functional block constituting the UE 200.

In the radio communication system 10, an SSB (SS/PBCH Block) including a synchronization signal (SS: Synchronization Signal) and a downlink physical broadcast channel (PBCH: Physical Broadcast Channel) may be used.

The SSB is mainly transmitted from the network at intervals such that the UE 200 can detect a cell ID and a reception timing at the start of communication. In NR, the SSB is also used to measure reception quality of each cell. A transmission period (periodicity) of the SSB may be specified as 5, 10, 20, 40, 80, or 160 milliseconds. Note that the UE 200 in an initial access may be assumed to have a transmission period of 20 milliseconds.

Secondly, a functional block configuration of the gNB 100 will be described.

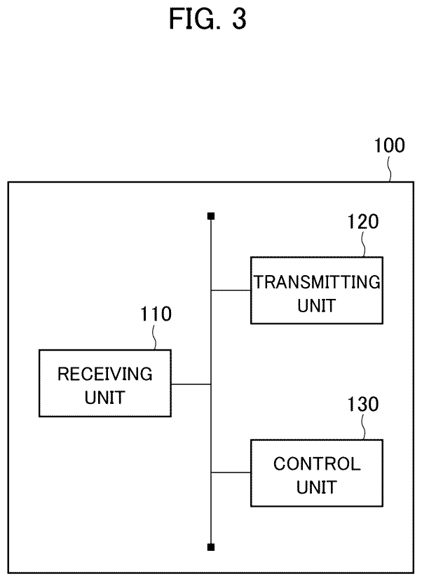

FIG. 3 is a functional block configuration diagram of the gNB 100. As illustrated in FIG. 3, the gNB 100 includes a receiving unit 110, a transmitting unit 120, and a control unit 130.

The receiving unit 110 receives various signals from the UE 200. The receiving unit 110 may receive a UL signal via the PUCCH or the PUSCH.

The transmitting unit 120 transmits various signals to the UE 200. The transmitting unit 120 may transmit a DL signal via the PDCCH or the PDSCH.

The control unit 130 controls the gNB 100.

### (3) Operation of Radio Communication System 10

Next, operation of the radio communication system 10 will be described. Specifically, operation examples of the radio communication system 10 including the gNB 100 and the UE 200, which can appropriately control retention or discard of configuration information, will be described.

### (3.1) Premise and Problem

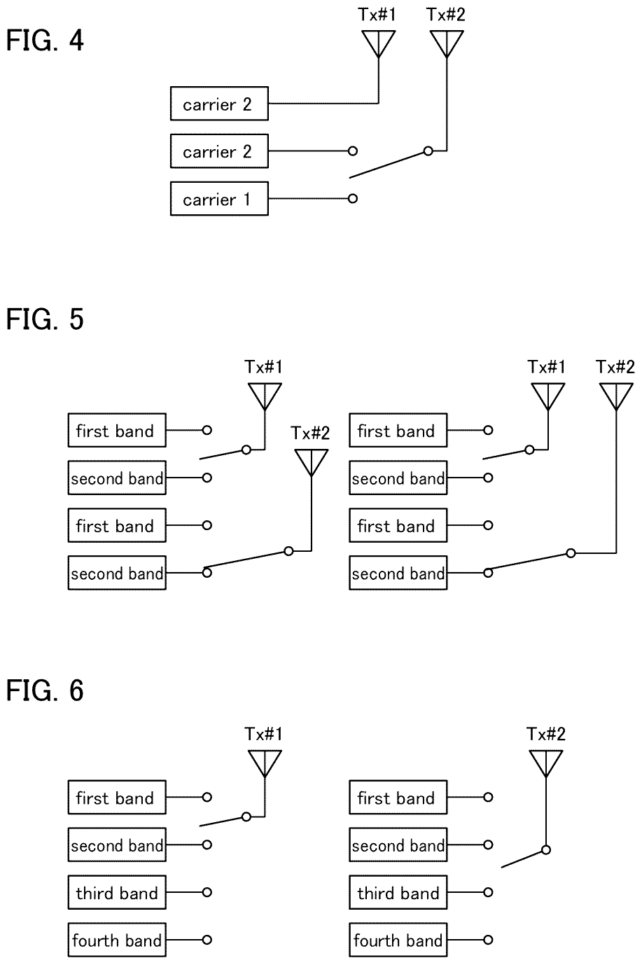

A problem involving in appropriately selecting component carriers included in a plurality of bands, will be described with reference to FIG. 4 and the like.

### Band Selection Operation in Release 16

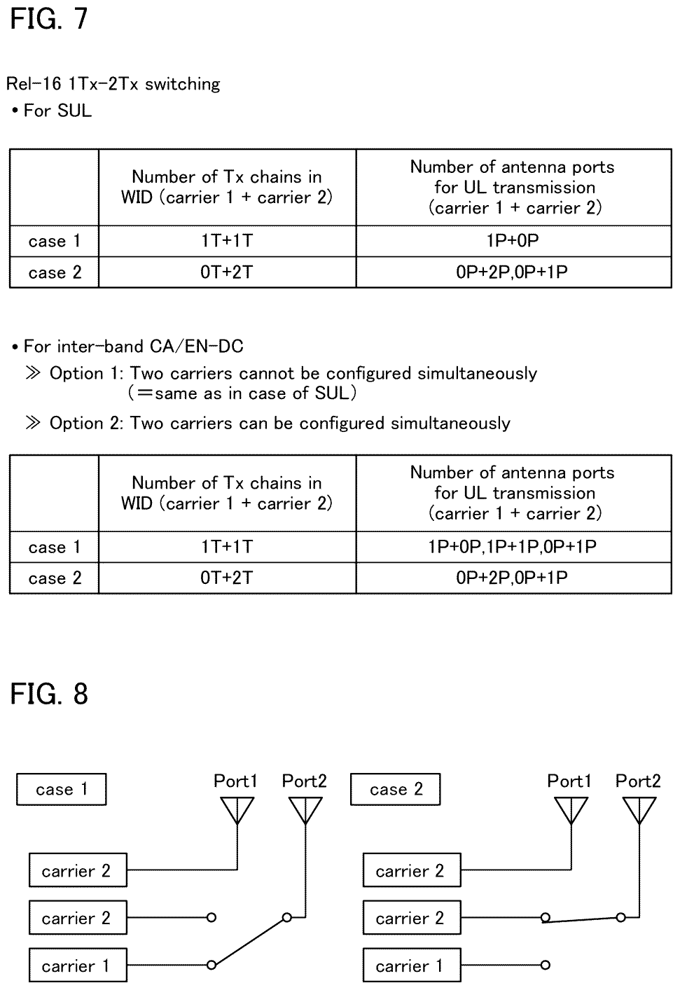

FIG. 4, FIG. 7, and FIG. 8 are diagrams each of which illustrates a band selection operation in Release 16. FIG. 4 illustrates two transmission antennas included in the UE 200, and a plurality of component carriers (carriers).

A first transmission antenna (TX#1) performs an uplink transmission using a component carrier (carrier 1) allocated to a specific band. A second transmission antenna (TX#2) is configured to be capable of selecting either one of two component carriers (carrier 1 and carrier 2) allocated to the specific band.

The carrier 1 may be interpreted as a component carrier allocated to a first band. The carrier 2 may be interpreted as a component carrier allocated to a second band which differs from the first band. The first band and the second band may be interpreted as an uplink band. The first band may be interpreted as a normal uplink (Normal UpLink: NUL) band. The second band may be interpreted as an uplink (Supplemental UpLink: SUL) band which supplements the first band.

In a case 1 of FIG. 8, an uplink transmission is performed using the carrier 2 via a port 1 of the first transmission antenna, and an uplink transmission is performed using the carrier 1 via a port 2 of the second transmission antenna. In a case 2 of FIG. 8, an uplink transmission is performed using the carrier 2 via the port 1 of the first transmission antenna, and an uplink transmission is performed using the carrier 2 via the port 2 of the second transmission antenna.

In a table shown on an upper side of FIG. 7, a case 1 “1T+1T” indicates that, when an option 1 is set, it is possible to perform an uplink transmission using one carrier 1 and perform an uplink transmission using one carrier 2. The option 1 may be interpreted as a setting that does not allow an uplink transmission in which two bands or two component carriers are selected simultaneously. The option 1 may be interpreted as a setting that disables an uplink transmission in which two bands or two component carriers are selected simultaneously.

A case 1 “1P+0P” indicates that, when the option 1 is set, it is possible to perform an uplink transmission using one carrier from only one antenna port. A case 2 “0T+2T” indicates that, when the option 1 is set, each of two transmission antennas can perform an uplink transmission using one carrier 2. A case 2 “0P+2P, 0P+1P” indicates that, when the option 1 is set, it is possible to perform an uplink transmission using one carrier 2 from each of two antenna ports or perform an uplink transmission using one carrier 2 from one of the two antenna ports.

In a table shown on a lower side of FIG. 7, a case 1 “1T+1T” indicates that, when an option 2 is set, it is possible to perform an uplink transmission using the carrier 1 and perform an uplink transmission using the carrier 2. The option 2 may be interpreted as a setting that allows an uplink transmission in which two bands or two component carriers are selected simultaneously. A case 1 “1P+0P, 1P+1P, 0P+1P” indicates that, when the option 2 is set, it is possible to perform an uplink transmission using one carrier or two carriers from one antenna port. A case 2 “0T+2T” indicates that, when the option 2 is set, each of two antenna ports can perform an uplink transmission using the carrier 2. A case 2 “0P+2P, 0P+1P” indicates that, when the option 2 is set, it is possible to perform an uplink transmission using the carrier 2 from each of two antenna ports or perform an uplink transmission using the carrier 2 from one of two antenna ports.

When the option 2 is set, the UE 200 compatible with Release 16 can perform carrier aggregation (CA) using two component carriers. This improves a throughput in the uplink in comparison with an uplink using one component carrier.

### Band Selection Operation in Release 17

FIG. 5 is a diagram that illustrates a band selection operation in Release 17. FIG. 5 illustrates two transmission antennas (“TX #1” and “TX #2”) included in the UE 200, and a plurality of bands. A first band and a second band may be interpreted as an uplink band. The second band may be interpreted as a second band which differs from the first band. The first band may be interpreted as a normal uplink (NUL) band. The second band may be interpreted as an uplink (SUL) band which supplements the first band.

A difference between Release 16 and Release 17 is in that the UE 200 compatible with Release 17 can select one or both of two bands, and perform carrier aggregation (CA) using 2CC or 3CC allocated to the selected band.

The 2CC may be interpreted as a plurality of component carriers allocated to the same band, that is, a specific single band. The 3CC may be interpreted as a combination of one or more component carriers allocated to two or more bands.

The UE200 compatible with Release 17 can, for example, select the first band and the second band, and perform carrier aggregation (CA) using a plurality of component carriers allocated to each of these bands. This improves a throughput in the uplink in comparison with the configuration of Release 16.

### Band Selection Operation in Release 18

FIG. 6 is a diagram that illustrates a band selection operation in Release 18. FIG. 6 illustrates two transmission antennas included in the UE 200 and a plurality of bands. As described above, the “TX #1” shown in the diagram is a first transmission antenna, and the “TX2” shown in the diagram is a second transmission antenna. Each of first to fourth bands may be interpreted as an uplink band.

A difference between Release 17 and Release 18 is in that the UE 200 compatible with Release 18 allows each of a plurality of antennas to select three or four bands, and perform carrier aggregation (CA) using component carriers allocated to the selected bands.

However, in the conventional technology, there is no provision for selecting which of the three or four bands in order to improve a throughput in the uplink. As a result, there is a problem that only one uplink band not to be expected to achieve a high throughput can be selected.

As solutions to such a problem, there are operation examples in which a plurality of bands can be appropriately selected, as described below. Note that each of the operation examples described below can be used alone or a combination of two or more of the operation examples can be used.

### (3.2) Operation Examples

The operation examples that can solve the above-described problem will be described below.

### (3.2.1) Operation Example 1

In this example, the following options can be set to the UE 200 configured to be capable of selecting four bands.

### Alt1

The following option 1 may be set to the UE 200. The option 1 may be interpreted as a setting that does not allow an uplink transmission in which two bands are selected simultaneously from among the four bands. The option 1 may be interpreted as a setting that does not select two bands from among the four bands.

The UE 200 to which the option 1 is set, may not select two bands from among the four bands. Specifically, the UE 200 may not select the following band pairs:
the first band (NUL band) and the second band (SUL band);
the first band (NUL band) and the third band (NUL band);
the first band (NUL band) and the fourth band (SUL band);
the second band (SUL band) and the third band (NUL band);
the second band (SUL band) and the fourth band (SUL band); and
the third band (NUL band) and the fourth band (SUL band).

The UE 200 to which the option 1 is set, may select any one band from among the four bands.

The first band may be interpreted as a band for a first uplink. The second band may be interpreted as a band for a second uplink which supplements the first uplink. The third band may be interpreted as a band for a third uplink in which frequency band is different from frequency bands in the first band and the second band. The fourth band may be interpreted as a band for a fourth uplink which supplements the third uplink. The first uplink and the third uplink may be interpreted as NUL. The second uplink and the fourth uplink may be interpreted as SUL. The first uplink and the third uplink may be interpreted as SUL. The second uplink and the fourth uplink may be interpreted as NUL.

Each of the four bands may include one or more component carriers therein.

### Alt2

The following option 2 may be set to the UE 200. The option 2 may be interpreted as a setting that allows an uplink transmission in which the first band (NUL band) and the third band (NUL band) are selected simultaneously from among the four bands. The option 2 may be interpreted as a setting that allows a simultaneous selection of the first band (NUL band) and the third band (NUL band) from among the four bands. Note that the UE 200 does not assume that an uplink transmission in which two SUL bands are selected simultaneously is performed, and does not assume that an uplink transmission in which the SUL band and the NUL band are selected simultaneously is performed. Specifically, in a case where the existing option 2 specified in Release 17 and the like is applied to Tx switching (band selection) in Release 18, the UE200 to which the option 2 is set does not select the SUL band and the NUL band simultaneously when the BC (band combination) for Tx switching including the SUL band has been set to the UE200. This enables the uplink transmission by the simultaneous selection of the first band (NUL band) and the third band (NUL band).

According to Alt2, since the first band (NUL band) and the third band (NUL band) can be selected from among the four bands, it is possible to suppress a selection of only one uplink band. Therefore, in comparison with a case where only one uplink band is selected, a throughput of the uplink can be improved. In addition, since the first band (NUL band) and the third band (NUL band) can be selected from among the four uplink bands, it is possible to dynamically select an optimal band (with good bandwidth and good propagation environment) in comparison with a case where component carriers allocated to two uplink bands are used as in Release 17.

### Alt 3

The UE 200 may set an option 3 that enables an uplink transmission in which two NUL bands are selected simultaneously, in addition to the option 1 and/or the option 2. In other words, the UE 200 may select only the first band (NUL band) and the third band (NUL band) from among the four bands. In this case, the UE 200 may not select two bands from among the four bands. Specifically, the UE 200 may not select the following band pairs:
the first band (NUL band) and the second band (SUL band);
the first band (NUL band) and the fourth band (SUL band);
the second band (SUL band) and the third band (NUL band);
the second band (SUL band) and the fourth band (SUL band); and
the third band (NUL band) and the fourth band (SUL band).

According to Alt3, in a case where the first band (NUL band) is a frequency band higher than the second band (SUL band) and the third band (NUL band) is a frequency band higher than the fourth band (SUL band), since wide frequency bands can be utilized by selecting the first band (NUL band) and the third band (NUL band), a throughput of the uplink transmission can be improved.

Note that the UE200 may set both of the option 1 and the option 2. In addition, the UE 200 may set both of the option 1 and the option 3. When both of the option 1 and the option 2 are set, the UE 200 can select the option 1 or the option 2 and perform a band selection corresponding to the selected option. When both of the option 1 and the option 3 are set, the UE 200 can select the option 1 or the option 3 and perform a band selection corresponding to the selected option.

According to this configuration, since a specific option can be selected from among a plurality of options, it is possible to operate the UE 200 prioritizing a throughput of uplink transmission, and it is also possible to prioritize suppressing power consumption due to the operation of the UE200 during the uplink transmission.

Note that in a case where the option 2 or the option 3 is set, if the UE 200 receives a certain instruction transmitted from a network, the UE 200 may select only SUL bands (a pair of SUL bands). The instruction may be interpreted as a transmission instruction for performing an uplink transmission using a combination of component carriers allocated to the SUL band and the NUL band.

According to this configuration, it is possible to select a pair of SUL bands without selecting a specified band, which can increase a throughput of the uplink transmission in comparison with a case where only one band is selected. Even if a desired throughput cannot be achieved even though two bands including a NUL band have been selected, it is possible to achieve a high throughput by selecting the pair of SUL bands.

If the UE 200 receives the above-described instruction, the UE 200 may select only SUL bands which are previously defined or specified.

### (3.2.2) Operation Example 2

In this example, the following options can be set to the UE 200 configured to be capable of selecting three bands.

### Alt1

The following option 1 may be set to the UE 200. The option 1 may be interpreted as a setting that does not allow an uplink transmission in which two bands are selected simultaneously from among the three bands. The option 1 may be interpreted as a setting that does not select two bands from among the three bands.

The UE 200 to which the option 1 is set, may not select two bands from among the three bands. Specifically, the UE 200 may not select the following band pairs:
the first band (NUL band) and the second band (SUL band);
the first band (NUL band) and the third band (NUL band);
the first band (NUL band) and the fourth band (SUL band);
the second band (SUL band) and the third band (NUL band);
the second band (SUL band) and the fourth band (SUL band); and
the third band (NUL band) and the fourth band (SUL band).

The UE 200 to which the option 1 is set, may select any one band from among the three bands.

The first band may be interpreted as a band for a first uplink. The second band may be interpreted as a band for a second uplink which supplements the first uplink. The third band may be interpreted as a band for a third uplink in which a frequency band is different from frequency bands in the first band and the second band. The third band may be interpreted as one or more bands which do not correspond to the first band and/or the second band. A plurality of NUL bands which do not correspond to the first band and/or the second band may be interpreted as including a specific first NUL band and a second NUL band in which a frequency band differs from a frequency band of the first NUL band. The first uplink and the third uplink may be interpreted as NUL. The second uplink may be interpreted as SUL. The first uplink and the third uplink may be interpreted as SUL. The second uplink may be interpreted as NUL.

Each of the three bands may include one or more component carriers therein.

### Alt2

The following option 2 may be set to the UE 200. The option 2 may be interpreted as a setting that allows an uplink transmission in which the first band (NUL band) and the third band (NUL band) are selected simultaneously from among the three bands. The option 2 may be interpreted as a setting that allows a simultaneous selection of the first band (NUL band) and the third band (NUL band) from among the three bands. Note that the UE 200 does not assume that an uplink transmission in which the SUL band and the NUL band are selected simultaneously is performed. Specifically, in a case where the existing option 2 specified in Release 17 and the like is applied to Tx switching (band selection) in Release 18, the UE 200 to which the option 2 is set does not select the SUL band and the NUL band simultaneously when the BC (band combination) for Tx switching including the SUL band has been set to the UE200. This enables the uplink transmission by the simultaneous selection of the first band (NUL band) and the third band (NUL band).

According to Alt2, since the first band (NUL band) and the third band (NUL band) can be selected from among the three bands, it is possible to suppress a selection of only one uplink band. Therefore, in comparison with a case where only one uplink band is selected, a throughput of the uplink can be improved. In addition, since the first band (NUL band) and the third band (NUL band) can be selected from among the three uplink bands, it is possible to dynamically select an optimal band (with good bandwidth and good propagation environment) in comparison with a case where component carriers allocated to two uplink bands are used as in Release 17.

### Alt 3

The UE 200 may set an option 3 that enables an uplink transmission in which two NUL bands are selected simultaneously, in addition to the option 1 and/or the option 2. In other words, the UE 200 may select only a pair of two NUL bands from among the three bands. Namely, either a pair of the first band (NUL band) and the third band (NUL band) or a pair of the third band (first NUL band described above) and an NUL band (second NUL band described above) in which a frequency band differs from a frequency band of the third band may be selected. In this case, the UE 200 may not select the following band pairs:
the first band (NUL band) and the second band (SUL band); and
the second band (SUL band) and the third band (NUL band).

According to Alt3, in a case where the first band (NUL band) and the third band (NUL) are frequency bands higher than the second band (SUL band), since wide frequency bands can be utilized by selecting the first band (NUL band) and the third band (NUL band), a throughput of the uplink transmission can be improved.

Note that the UE 200 may set both of the option 1 and the option 2 described above. Also the UE 200 may set both of the option 1 and the option 3 described above. In a case where both of the option 1 and the option 2 are set, the UE 200 can select the option 1 or the option 2 and perform a band selection corresponding to the selected option. In a case where both of the option 1 and the option 3 are set, the UE 200 can select the option 1 or the option 3 and perform a band selection corresponding to the selected option

According to this configuration, since a specific option can be selected from among a plurality of options, it is possible to operate the UE 200 prioritizing a throughput of uplink transmission, and it is also possible to prioritize suppressing power consumption due to the operation of the UE200 during uplink transmission.

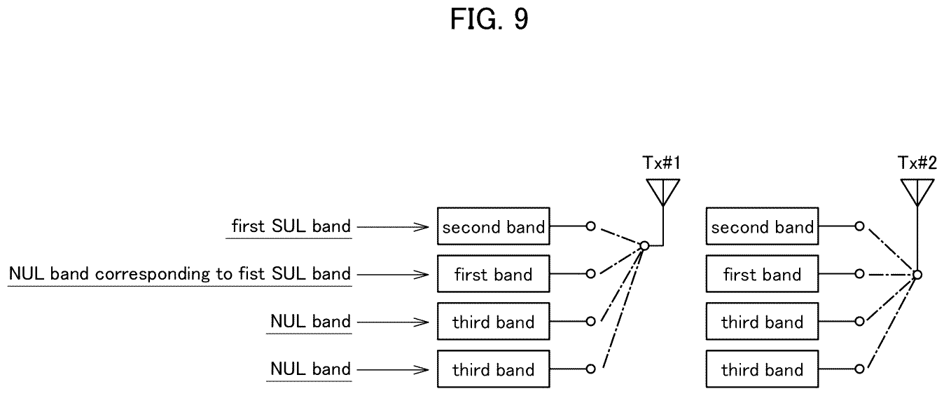

FIG. 9 is a diagram illustrating the operation example 2. In a case where the option 2 or the option 3 is set, if the UE 200 receives a certain instruction transmitted from a network, the UE 200 may select only the second band (SUL band) illustrated in FIG. 9. The instruction may be interpreted as a transmission instruction for performing an uplink transmission using a combination of component carriers allocated to the SUL band and the NUL band. In this case, the UE 200 does not select a specified band, but selects the SUL band and performs uplink transmission using a component carrier allocated to the selected SUL band. In other words, the UE 200 ignores uplink transmission scheduling when a pair of the SUL band and a band other than the SUL band is selected.

According to Alt6, since only one SUL band is selected instead of a pair of two bands, the UE200 can prioritize suppressing of power consumption due to the operation of the UE 200 during uplink transmission.

### (3.2.3) Operation Example 3

In this example, the UE 200 configured to be capable of selecting the four bands or the three bands, may notify the NW of information, which indicates the respective band combinations of the above-described options 2 to 4, as UE Capability. Also, the UE 200 may notify the NW of information, which indicates whether nor not these band combinations can be applied to any of the above-described Alts, as UE Capability.

Note that this example may be applied in a case where more than four bands are set as selectable bands. Port #1 (or 2) illustrated in FIG. 8 and the like, may be read as Tx chain #1 (or 2), or as Tx #1 (or 2). Specifically, if the number of CCs per band is 1, the following cases can also be included in this example:
if one component carrier is allocated to each of the four bands, the total number of component carriers for the four bands is four;
If two component carriers are allocated to each of the four bands, the total number of component carriers for the four bands is eight; and
If one component carrier is allocated to one of the four bands and two component carriers are allocated to the remaining bands, the total number of component carriers for the four bands is between five and seven.

### Supplementary Note

The terminal and the base station of this embodiment may be configured as the terminal and the base station described in each of the following items:

### Item 1

A terminal including: a control unit that selects a plurality of bands from among a first band for a first uplink, a second band for a second uplink which supplements the first uplink, a third band for a third uplink in which a frequency band is different from frequency bands in the first band and the second band, and a fourth band for a fourth uplink which supplements the third uplink; and a transmitting unit that performs an uplink transmission using a combination of component carriers allocated to the selected plurality of bands;

### Item 2

The terminal according to claim 1, wherein the control unit selects the first band and the third band;

### Item 3

The terminal according to claim 1 or 2, wherein the control unit sets the second band and the fourth band to be unselected;

### Item 4

A terminal including a control unit that selects a plurality of bands from among a first band for a first uplink, a second band for a second uplink which supplements the first uplink, and a third band for a third uplink in which a frequency band is different from frequency bands in the first band and the second band; and a transmitting unit that performs an uplink transmission using a combination of component carriers included in the selected plurality of bands;

### Item 5

The terminal according to claim 4, wherein the control unit selects the first band and the third band; and

### Item 6

The terminal according to claim 4 or 5, wherein the control unit sets the second band and the third band to be unselected.

### (4) Action and Effect

According to the embodiment, the following action and effect can be obtained. Specifically, the terminal according to the present embodiment may include a control unit that selects a plurality of bands from among a first band for a first uplink, a second band for a second uplink which supplements the first uplink, a third band for a third uplink in which a frequency band is different from frequency bands in the first band and the second band, and a fourth band for a fourth uplink which supplements the third uplink; and a transmitting unit that performs an uplink transmission using a combination of component carriers allocated to the selected plurality of bands.

By this configuration, since the two uplink bands can be selected from among the four bands, it is possible to suppress a selection of only one uplink band. Therefore, in comparison with a case where only one uplink band is selected, a throughput of the uplink can be improved. In addition, since the plurality uplink bands can be selected from among the four uplink bands, it is possible to perform an uplink transmission using a wider frequency band in comparison with a case of using component carriers allocated to the two uplink bands as in Release 17.

The terminal according to the present embodiment may select the first band and the third band. Thereby, in a case where the first band (NUL band) is a frequency band higher than the second band (SUL band) and the third band (NUL band) is a frequency band higher than the fourth band (SUL band), since wide frequency bands can be utilized by selecting the first band (NUL band) and the third band (NUL band), a throughput of the uplink transmission can be improved.

The control unit of the terminal according to the present embodiment may set the second band and the fourth band to be unselected. By this configuration, in a case where the first band (NUL band) is a frequency band higher than the second band (SUL band) and the third band (NUL band) is a frequency band higher than the fourth band (SUL band), since it is possible to select only the first band (NUL band) and the third band (NUL band) and utilize wide frequency bands, a throughput of the uplink transmission can be improved.

The terminal according to the present embodiment may include a control unit that selects a plurality of bands from among a first band for a first uplink, a second band for a second uplink which supplements the first uplink, and a third band for a third uplink in which a frequency band is different from frequency bands in the first band and the second band; and a transmitting unit that performs an uplink transmission using a combination of component carriers included in the selected plurality of bands.

By this configuration, since the two uplink bands can be selected from among the bands, it is possible to suppress a selection of only one uplink band. Therefore, in comparison with a case where only one uplink band is selected, a throughput of the uplink can be improved. In addition, since the plurality uplink bands can be selected from among the three uplink bands, it is possible to perform an uplink transmission using a wider frequency band in comparison with a case of using component carriers allocated to the two uplink bands as in Release 17.

### (5) Other Embodiments

Although the embodiment has been described, the present invention is not limited to the descriptions of the embodiment, and it is obvious to those skilled in the art that various modifications and improvements can be made.

In the above-described disclosure, configure, activate, update, indicate, enable, specify, and select may be read interchangeably. Similarly, link, associate, correspond, and map may be read interchangeably, and allocate, assign, monitor, and map may also be read interchangeably.

Furthermore, specific, dedicated, UE-specific, and UE- individual may be read interchangeably. Similarly, common, shared, group-common, UE-common, and UE-shared may be read interchangeably.

In this disclosure, a precoding, a precoder, a weight (precoding weight), a Quasi-Co-Location (QCL), a Transmission Configuration Indication state (TCI state), a spatial relation, a spatial domain filter, a transmit power, a phase rotation, an antenna port, an antenna port group, a layer, the number of layers, a rank, a resource, a resource set, a resource group, a beam, a beam width, a beam angle, an antenna, an antenna element, a panel, and the like may be used interchangeably.

Note that the block diagrams (FIG. 2 and FIG. 3) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit)”, a “transmitter”, and the like. The method for implementing each component is not particularly limited as described above.

The gNB 100, the UE 200 (apparatuses) and the AMF which are described above may function as a computer that executes the processes of the radio communication method of the present disclosure. FIG. 10 is a diagram to illustrating an example of a hardware structure of the gNB 100 and the UE 200. As illustrated in FIG. 10, the apparatuses may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a unit, and so on can be interchangeably interpreted. The hardware structure of the apparatuses may be configured to include one or more of apparatuses shown in the drawings, or may be configured not to include part of apparatuses.

Each functional block of the apparatuses (see FIG. 2 and FIG. 3) is implemented by any of hardware elements of the computer apparatus or a combination of the hardware elements.

Each function of the apparatuses is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of an optical disk such as a Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and other appropriate storage media. The storage 1003 may be referred to as “auxiliary storage apparatus”. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the apparatuses may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, Downlink Control Information (DCI), Uplink Control Information (UCI)), higher layer signaling (for example, RRC signaling, Medium Access Control (MAC) signaling, broadcast information (Master Information Block (MIB), System Information Block (SIB), and so on)), and other signals or combinations of these. Also, RRC signaling may be referred to as an “RRC message”, and can be, for example, an RRC Connection Setup message, an RRC Connection Reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these, and the like. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by the gNB 100 may, in some cases, be performed by an upper node of the gNB 100. In a network including one or a plurality of network nodes with the gNB 100, it is clear that various operations that are performed to communicate with the UE 200 can be performed by at least one of the gNB 100 and one or more network nodes (for example, MME, S-GW, and so on may be possible, but these are not limiting) other than the gNB 100. According to the above, a case is described in which there is a single network node other than the gNB 100. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies and wireless technologies is included within the definition of the transmission medium.

Information, a signal, or the like, described in the present specification may be represented by using any one of various different technologies. For example, data, an instruction, a command, information, a signal, a bit, a symbol, a chip, for the like, described throughout the present application, may be represented by a voltage, an electric current, electromagnetic waves, magnetic fields, a magnetic particle, optical fields, a photon, or a combination thereof.

It should be noted that a term used in the present specification and a term required for understanding of the present specification may be replaced by a term having the same or similar meaning. For example, at least one of a channel and a symbol may be a signal (signaling). Further, a signal may be a message. Further, the Component Carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “Base Station (BS)”, a “radio base station”, a “fixed station”, a “NodeB”, an “eNB (eNodeB)”, a “gNB (gNodeB)”, an “access point”, a “transmission point”, a “reception point”, a “transmission/reception point”, a “cell”, a “sector”, a “cell group”, a “carrier”, a “component carrier”, and so on can be used interchangeably. The gNB 100 may be referred to as the terms such as a “macro cell”, a “small cell”, a “femto cell”, a “pico cell”, and so on.

The gNB 100 can accommodate one or a plurality of (for example, three) cells (also called sectors). When the gNB 100 accommodates a plurality of cells, the entire coverage area of the gNB 100 can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of the gNB 100 and a base station subsystem that provides communication services within this coverage.

In the present disclosure, the terms “Mobile Station (MS)”, “user terminal”, “User Equipment (UE)”, and “terminal” may be used interchangeably.

A mobile station may be referred to as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other appropriate terms in some cases.

At least one of the gNB 100 and the mobile station may be referred to as a “transmitting apparatus”, a “receiving apparatus”, a “radio communication apparatus”, and so on. Note that at least one of the gNB 100 and the mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of the gNB 100 and the mobile station also includes an apparatus which does not necessarily move during communication operation. For example, at least one of the gNB 100 and the mobile station may be an Internet of Things (IoT) device such as a sensor.

Furthermore, the gNB 100 in the present disclosure may be interpreted as a user station (user terminal, the same applies hereinafter). For example, each aspect/embodiment of the present disclosure may be applied to the structure that replaces a communication between the gNB 100 and the user station with a communication between a plurality of user stations (for example, which may be referred to as “Device-to-Device (D2D)”, “Vehicle-to-Everything (V2X)”, and the like). In this case, the user stations may have the functions of the gNB 100 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user station in the present disclosure may be interpreted as the gNB 100. In this case, the gNB 100 may have the functions of the user station. A radio frame may be constituted of one or a plurality of frames in the time domain. Each of one or a plurality of frames in the time domain may be referred to as a “subframe”. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a SubCarrier Spacing (SCS), a bandwidth, a symbol length, a cyclic prefix length, a Transmission Time Interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols less than the number of slots. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, the gNB 100 performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot”, or the like. A TTI that is shorter than a normal TTI may be referred to as a “shortened TTI”, a “short TTI”, a “partial or fractional TTI”, a “shortened subframe”, a “short subframe”, a “mini- slot”, a “sub-slot”, a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “Sub-Carrier Group (SCG)”, a “Resource Element Group (REG)”, a “PRB pair”, an “RB pair” and so on.

Furthermore, a resource block may be constituted of one or a plurality of Resource Elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or coupling between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS”, and may be referred to as a “pilot”, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up, search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, comparing and the like. That is, “determining” may be regarded as a certain type of action related to determining. Furthermore, “determining” may be regarded as “assuming”, “expecting”, “considering”, and the like.

In this disclosure, the term “A and B are different” may mean “A and B are different from each other”. It should be noted that the term “A and B are different” may mean “A and B are different from C”. Terms such as “separated” or “combined” may be interpreted in the same way as the above-described “different”.

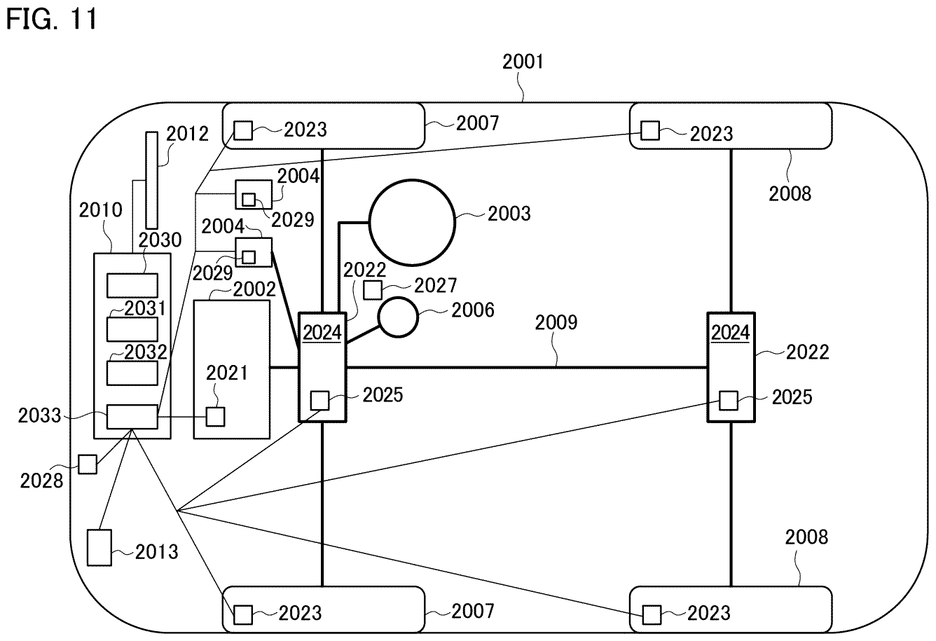

FIG. 11 illustrates an example of a configuration of a vehicle 2001. As illustrated in FIG. 11, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021 to 2027 provided in the vehicle 2001. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, and an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2028 provided in the vehicle 1.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, the gNB 100, a mobile station, or the like.

The communication module 2013 transmits the current signal from the current sensor, which is input to the electronic control unit 2010, to external devices through radio communication. In addition, the communication module 2013 transmits to external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2028, etc., mounted in the vehicle 2001.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### Explanation of Reference Numerals

10 radio communication system
20 NG-RAN
100 gNB
110 receiving unit
120 transmitting unit
130 control unit
200 UE
210 radio signal transmitting and receiving unit
220 amplifier unit
230 modulation and demodulation unit
240 control signal and reference signal processing unit
250 encoding and decoding unit
260 data transmitting and receiving unit
270 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 revolution sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a control unit that selects a plurality of bands from among a first band for a first uplink, a second band for a second uplink which supplements the first uplink, a third band for a third uplink in which a frequency band is different from frequency bands in the first band and the second band, and a fourth band for a fourth uplink which supplements the third uplink; and
a transmitting unit that performs an uplink transmission using a combination of component carriers allocated to the selected plurality of bands.

2. The terminal according to claim 1, wherein the control unit selects the first band and the third band.

3. The terminal according to claim 1, wherein the control unit sets the second band and the fourth band to be unselected.

4. A terminal comprising:
a control unit that selects a plurality of bands from among a first band for a first uplink, a second band for a second uplink which supplements the first uplink, and a third band for a third uplink in which a frequency band is different from frequency bands in the first band and the second band; and
a transmitting unit that performs an uplink transmission using a combination of component carriers included in the selected plurality of bands.

5. The terminal according to claim 4, wherein the control unit selects the first band and the third band.

6. The terminal according to claim 4, wherein the control unit sets the second band and the third band to be unselected.
